(19) United States
(12) Patent Application Publication
(10) Pub. No.: US 2026/0103212 A1
(43) Pub. Date: Apr. 16, 2026

(54) VEHICLE DRIVING ASSISTANCE APPARATUS

(71) Applicant: TOYOTA JIDOSHA KABUSHIKI KAISHA, Aichi (JP)

(72) Inventor: Hiroyuki SAKAKIBARA, Toyota-shi (JP)

(21) Appl. No.: 19/321,296

(22) Filed: Sep. 8, 2025

(30) Foreign Application Priority Data
Oct. 15, 2024 (JP) 2024-179824

(51) Int. Cl. B60W 50/14; B60W 30/14

(52) U.S. Cl. CPC B60W 50/14; B60W 30/146; B60W 2050/143; B60W 2050/146; B60W 2555/20; B60W 2555/60

(57) ABSTRACT

A vehicle driving assistance apparatus performs a normal notification when an applicable speed limit to be applied to a host vehicle changes. The normal notification is a notification that informs an operator of the host vehicle of the changed applicable speed limit. The electronic control unit is configured to perform an advance notification when the electronic control unit recognizes that the applicable speed limit will change and a predetermined situation condition related to a driving situation of the host vehicle is satisfied before the applicable speed limit changes. The advance notification is a notification that informs the operator that the applicable speed limit will change.

### CROSS-REFERENCE TO RELATED APPLICATIONS

This application claims priority to Japanese patent application No. JP 2024-179824 filed on Oct. 15, 2024, the content of which is hereby incorporated by reference in its entirety.

### BACKGROUND

### Field

The present invention relates to a vehicle driving assistance apparatus.

### Description of the Related Art

There is known a vehicle driving assistance apparatus which alerts a driver that a traveling speed of a host vehicle exceeds a speed limit (see, for example, Japanese Patent Application Publication No. 2019-191861).

If information related to the speed limit, such as the fact that the traveling speed of the host vehicle exceeds the speed limit, is provided to the driver at the time such an event occurs, there is a possibility that the driver's attention may be distracted.

### SUMMARY

An object of the present invention is to provide a vehicle driving assistance apparatus capable of suppressing distraction of an operator of the host vehicle caused by the provision of information related to the speed limit.

A vehicle driving assistance apparatus according to the present invention comprises an electronic control unit configured to perform a normal notification when an applicable speed limit to be applied to a host vehicle changes. The normal notification is a notification that informs an operator of the host vehicle of the changed applicable speed limit. The electronic control unit is configured to perform an advance notification when the electronic control unit recognizes that the applicable speed limit will change and a predetermined situation condition related to a driving situation of the host vehicle is satisfied before the applicable speed limit changes. The advance notification is a notification that informs the operator that the applicable speed limit will change.

In a situation where a predetermined situation condition is satisfied, if the operator of the host vehicle is informed of the change in the applicable speed limit after the speed limit changes, the operator's attention may be distracted. In other words, in a situation where the predetermined situation condition is satisfied, if information regarding the speed limit such as information indicating that the applicable speed limit changes, is provided to the operator of the host vehicle after the applicable speed limit changes, there is a possibility that the operator's attention will be distracted. According to the present invention, when the predetermined situation condition is satisfied, the operator of the host vehicle is informed that the applicable speed limit will change before the applicable speed limit changes. Therefore, distraction of the operator's attention can be suppressed.

According to an aspect of the present invention, the electronic control unit may be configured to perform the advance notification in a different manner from the normal notification, even when the electronic control unit informs the operator of the same applicable speed limit.

According to this aspect of the present invention, it is possible to reliably cause the operator of the host vehicle to understand that the current notification is the advance notification rather than the normal notification.

According to another aspect of the present invention, the electronic control unit may be configured to perform the advance notification at an earlier timing when a traveling speed of the host vehicle is greater than the applicable speed limit informed by the advance notification, compared to when the traveling speed is lower than the applicable speed limit.

According to this aspect of the present invention, the advance notification is performed at a more appropriate timing.

According to further another aspect of the present invention, the predetermined situation condition may be a condition that the weather in the vicinity of the host vehicle is inclement.

According to this aspect of the present invention, when the weather around the host vehicle is adverse, the advance notification is performed. Therefore, the operator of the host vehicle is informed of the change in the applicable speed limit at a more appropriate timing.

Elements of the invention are not limited to elements of embodiments and modified examples of the invention described with reference to the drawings.

The other objects, features and accompanied advantages of the invention can be easily understood from the embodiments and the modified examples of the invention.

### BRIEF DESCRIPTION OF THE DRAWINGS

FIG. 1 is a view showing a vehicle driving assistance apparatus according to an embodiment of the present invention.

FIG. 2 is a flowchart showing a routine executed by the vehicle driving assistance apparatus according to the embodiment of the present invention.

FIG. 3 is a view showing a road sign image and an auxiliary sign image.

### DETAILED DESCRIPTION

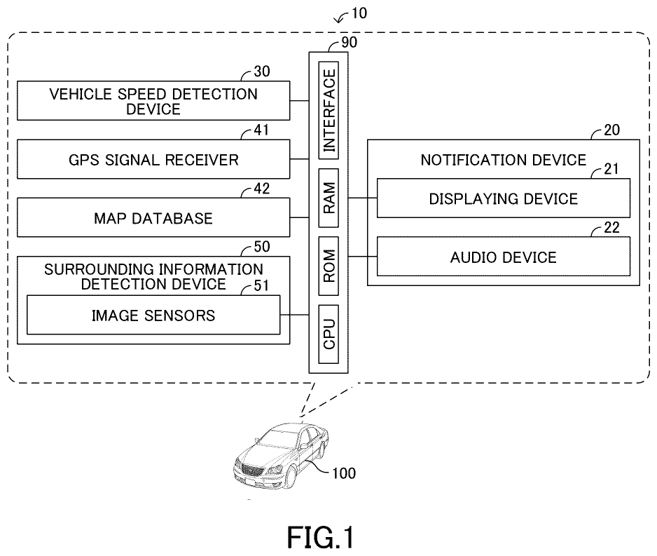

Hereinafter, a vehicle driving assistance apparatus according to an embodiment of the present invention will be described with reference to the drawings. FIG. 1 shows the vehicle driving assistance apparatus 10 according to the embodiment of the present invention. The vehicle driving assistance apparatus 10 is mounted on a host vehicle 100. In the following description, the case where an operator of the host vehicle 100 is a driver of the host vehicle 100 (i.e., a person who boards and drives the host vehicle 100) will be taken as an example to explain the vehicle driving assistance apparatus 10. However, the operator of the host vehicle 100 may alternatively be a remote operator of the host vehicle 100 (i.e., a person who drives the host vehicle 100 remotely without boarding the host vehicle 100). It should be noted that in the following description, the driver of the host vehicle 100 is simply referred to as “the driver.”

As shown in FIG. 1, the vehicle driving assistance apparatus 10 includes an ECU (Electronic Control Unit) 90 functioning as a control device. The ECU 90 includes a microcomputer as its main component. The microcomputer comprises a CPU, a computer-readable storage medium, and interfaces. The storage medium includes ROM, RAM, and non-volatile memory. The CPU is configured to execute instructions, programs, or routines stored in the storage medium to implement various functions. Specifically, in this example, the vehicle driving assistance apparatus 10 stores, in the storage medium, programs that implement various control processes executed by the vehicle driving assistance apparatus 10.

It should be noted that in this example, the vehicle driving assistance apparatus 10 includes only the ECU 90. However, the vehicle driving assistance apparatus 10 may alternatively be configured to include a plurality of ECUs, with the functions of the vehicle driving assistance apparatus 10, described below, distributed among the respective ECUs.

The vehicle driving assistance apparatus 10 may also be configured to update the programs stored in the storage medium via wireless communication (e.g., internet communication) with an external device.

Furthermore, the vehicle driving assistance apparatus 10 is applicable not only to vehicles driven by manual operation of the operator, but also to vehicles driven by both manual and autonomous operation.

The host vehicle 100 is equipped with a notification device 20, a vehicle speed detection device 30, a GPS signal receiver 41, a map database 42, and a surrounding information detection device 50.

The notification device 20 is a device configured to inform the driver of various types of information. The notification device 20 includes a displaying device 21 and an audio device 22.

The displaying device 21 is a device configured to display various images. The displaying device 21 includes, for example, a display panel. The displaying device 21 is electrically connected to the ECU 90. The vehicle driving assistance apparatus 10 displays various images by the displaying device 21.

The audio device 22 is a device configured to output various sounds and/or voices. The audio device 22 includes, for example, a speaker. The audio device 22 is electrically connected to the ECU 90. The vehicle driving assistance apparatus 10 outputs various sounds and/or voices by the audio device 22.

The vehicle speed detection device 30 is a device configured to detect a vehicle speed V of the host vehicle 100. The vehicle speed V represents a traveling speed of the host vehicle 100. The vehicle speed detection device 30 includes, for example, wheel rotation speed sensors provided at respective wheels of the host vehicle 100. The vehicle speed detection device 30 is electrically connected to the ECU 90. The vehicle driving assistance apparatus 10 acquires the vehicle speed V by the vehicle speed detection device 30.

The GPS signal receiver 41 is a device configured to receive GPS signals. The GPS signal receiver 41 is electrically connected to the ECU 90. The vehicle driving assistance apparatus 10 receives GPS signals via the GPS signal receiver 41. The vehicle driving assistance apparatus 10 acquires a current position of the host vehicle 100 based on the GPS signals.

The map database 42 is a device storing map information IM. The map database 42 is electrically connected to the ECU 90. The vehicle driving assistance apparatus 10 acquires the map information IM from the map database 42.

The surrounding information detection device 50 is a device configured to detect information on surroundings of the host vehicle 100. In this example, the surrounding information detection device 50 includes a plurality of image sensors 51. Each image sensor 51 is, for example, a camera sensor. The vehicle driving assistance apparatus 10 acquires surrounding information of the host vehicle 100 as image information IC by the image sensors 51.

Next, the operation of the vehicle driving assistance apparatus 10 will be described. The vehicle driving assistance apparatus 10 performs a speed limit notification to inform the driver of an applicable speed limit Vapp. The applicable speed limit Vapp is the speed limit Vlim applied to the host vehicle 100. In this example, the speed limit notification includes a normal notification, a prior notification, and a preliminary notification.

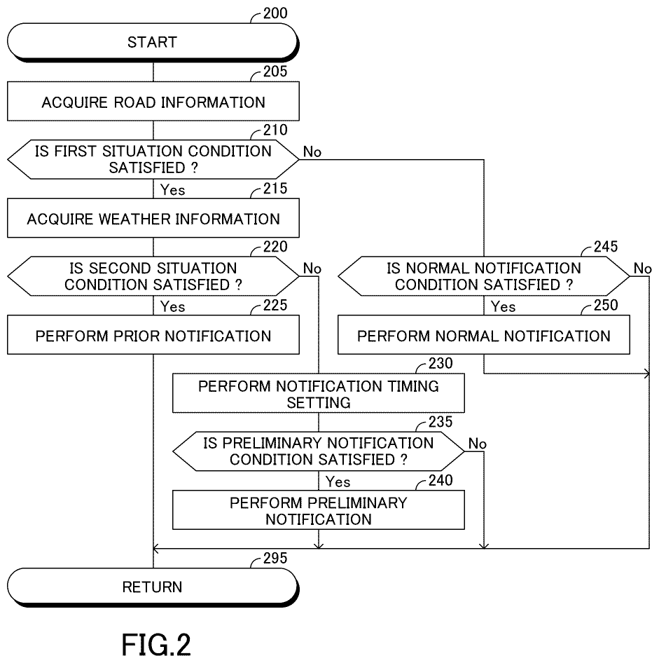

The vehicle driving assistance apparatus 10 executes a routine shown in FIG. 2 at predetermined time intervals and performs the speed limit notification when conditions are satisfied. Therefore, at a predetermined timing, the vehicle driving assistance apparatus 10 starts a process from a step S200 of the routine shown in FIG. 2. Then, the vehicle driving assistance apparatus 10 proceeds with the process to a step S205 to acquire road information IR. Subsequently, the vehicle driving assistance apparatus 10 proceeds with the process to a step S210.

The road information IR is information on a scheduled travel road RD.

The scheduled travel road RD is a road on which the host vehicle 100 is expected to travel. The road information IR is included in the map information IM. Therefore, the road information IR is acquired from the map information IM.

When the vehicle driving assistance apparatus 10 proceeds with the process to the step S210, the vehicle driving assistance apparatus 10 determines whether a first situation condition C1 is satisfied.

The first situation condition C1 is a predetermined situation condition that is satisfied when the current vehicle speed V is greater than a new applicable speed limit Vapp_new. The new applicable speed limit Vapp_new is the speed limit Vlim that will newly apply to the host vehicle 100 in place of the current applicable speed limit Vapp, if the host vehicle 100 continues traveling along the scheduled travel road RD. The current applicable speed limit Vapp is the speed limit Vlim currently applied to the host vehicle 100. It should be noted that both the current applicable speed limit Vapp and the new applicable speed limit Vapp_new are acquired from the road information IR.

The first situation condition C1 is also satisfied when a curvature radius RC of the scheduled travel road RD is smaller than a predetermined curvature radius RCth. The predetermined curvature radius RCth is set to a minimum curvature radius RCmin at which the host vehicle 100 is considered capable of safely traveling on the scheduled travel road RD when the host vehicle 100 travels at the current vehicle speed V. Alternatively, the predetermined curvature radius RCth may be set to a value larger than but close to the minimum curvature radius RCmin. It should be noted that the curvature radius RC of the scheduled travel road RD is acquired from the road information IR.

Furthermore, the road type of the scheduled travel road RD may be considered in determining whether the first situation condition C1 is satisfied.

The road type may indicate, for example, whether the scheduled travel road RD is a general road or an expressway. Furthermore, the road type may indicate, for example, whether the scheduled travel road RD is a one-lane or two-lane road. Furthermore, the road type may indicate, for example, whether the scheduled travel road RD has good or poor visibility. In this case, if the scheduled travel road RD is of a type considered easy for the host vehicle 100 to safely travel, the first situation condition C1 is less likely to be satisfied.

When the vehicle driving assistance apparatus 10 determines “Yes” in the step S210, the vehicle driving assistance apparatus 10 proceeds with the process to a step S215 to acquire weather information IW. Then, the vehicle driving assistance apparatus 10 proceeds with the process to a step S220.

The weather information IW is information on weather in an area where the host vehicle 100 is traveling. In particular, the weather information IW is information on weather in an area that includes the scheduled travel road RD. The weather information IW is acquired from the image information IC.

When the vehicle driving assistance apparatus 10 proceeds with the process to the step S220, the vehicle driving assistance apparatus 10 determines whether a second situation condition C2 is satisfied.

The second situation condition C2 is a predetermined situation condition that is satisfied when at least one of a rain condition that it is raining, a snow condition that it is snowing, and a fog condition that it is foggy. In other words, the second situation condition C2 is a condition that the weather around the host vehicle 100 is inclement. It should be noted that it is determined whether at least one of the rain condition, the snow condition, and the fog condition is satisfied, based on the weather information IW.

Moreover, the second situation condition C2 may also be satisfied when at least one of a rainfall amount condition that a rainfall amount per unit time is equal to or greater than a predetermined rainfall amount and a snowfall amount condition that a snowfall amount per unit time is equal to or greater than a predetermined snowfall amount). It is determined whether at least one of the rainfall amount condition and the snowfall amount condition is satisfied, based on the weather information IW.

Additionally, the second situation condition C2 may be satisfied when at least one of a snow accumulation amount condition that a snow accumulation amount is equal to or greater than a predetermined snow accumulation amount and a dense fog condition that a fog density is equal to or greater than a predetermined density. It is determined whether at least one of the snow accumulation amount condition and the dense fog condition is satisfied, based on the weather information IW.

Furthermore, the road type of the scheduled travel road RD may be considered in determining whether the second situation condition C2 is satisfied. In this case, if the scheduled travel road RD is of a type considered easy for the host vehicle 100 to safely travel, the second situation condition C2 is less likely to be satisfied.

When the vehicle driving assistance apparatus 10 determines “Yes” in the step S220, the vehicle driving assistance apparatus 10 proceeds with the process to a step S225 to perform the prior notification. Then, the vehicle driving assistance apparatus 10 proceeds with the process to a step S295 to terminate the process of this routine once.

The prior notification is an advance notification informing the driver that a new speed limit Vnew will be applied to the host vehicle 100. In other words, the prior notification is an advance notification informing the driver that the applicable speed limit Vapp will change.

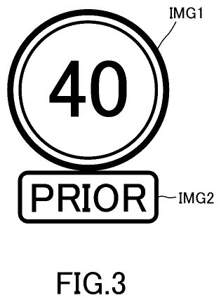

In this example, the prior notification is performed by informing the driver by the notification device 20 that a new speed limit Vnew will be applied to the host vehicle 100. More specifically, as shown in FIG. 3, the prior notification is performed by displaying a road sign image IMG1 and an auxiliary sign image IMG2 on the displaying device 21. The road sign image IMG1 is modeled after a road sign indicating the new applicable speed limit Vapp_new. The auxiliary sign image IMG2 is modeled after an auxiliary sign displaying the word “Prior. ” The auxiliary sign image IMG2 is displayed adjacent to and below the road sign image IMG1. Additionally or alternatively, the prior notification may be performed by outputting an audio message indicating the new applicable speed limit Vapp_new via the audio device 22.

As described, when the vehicle driving assistance apparatus 10 recognizes that the applicable speed limit Vapp will change, and the driving situation of the host vehicle 100 satisfies the first situation condition C1 and the second situation condition C2, the vehicle driving assistance apparatus 10 is configured to perform the advance notification to inform the driver that the applicable speed limit Vapp will change before the applicable speed limit Vapp changes.

According to the vehicle driving assistance apparatus 10, even when the same speed value of the applicable speed limit Vapp is informed in the prior notification and the normal notification, the prior notification is performed in a manner different from that of the normal notification.

On the other hand, when the vehicle driving assistance apparatus 10 determines “No” in the step S220, the vehicle driving assistance apparatus 10 proceeds with the process to a step S230 to perform a notification timing setting. Then, the vehicle driving assistance apparatus 10 proceeds with the process to a step S235.

The notification timing setting is a process of setting a notification distance threshold Dth. According to this notification timing setting, when a speed difference ΔV between the new applicable speed limit Vapp_new and the current vehicle speed V is large, the notification distance threshold Dth is set to a larger value, compared to when the speed difference ΔV is small. Specifically, in this example, according to the notification timing setting, the larger the speed difference ΔV, the larger the notification distance threshold Dth is set.

The notification distance threshold Dth may be acquired from a map or lookup table using the speed difference ΔV as an input argument.

It should be noted that the notification distance threshold Dth may also be set in consideration of an accelerator-off deceleration rate Goff in addition to the speed difference ΔV. For example, the smaller the accelerator-off deceleration rate Goff, the larger the notification distance threshold Dth may be set. It should be noted that the accelerator-off deceleration rate Goff is the deceleration of the host vehicle 100 realized when an accelerator pedal of the host vehicle 100 is released.

When the vehicle driving assistance apparatus 10 proceeds with the process to the step S235, the vehicle driving assistance apparatus 10 determines whether a preliminary notification condition C3 is satisfied.

The preliminary notification condition C3 is satisfied when a remaining distance D becomes less than or equal to the notification distance threshold Dth. The remaining distance D is the distance between the current position of the host vehicle 100 and the point at which the new speed limit Vnew starts to apply to the host vehicle 100.

When the vehicle driving assistance apparatus 10 determines “Yes” in the step S235, the vehicle driving assistance apparatus 10 proceeds with the process to a step S240 to perform the preliminary notification. Then, the vehicle driving assistance apparatus 10 proceeds with the process to the step S295 to terminate the process of this routine once.

The preliminary notification is an advance notification to inform the driver that the new speed limit V_new will be applied to the host vehicle 100. In other words, the preliminary notification is an advance notification to inform the driver that the applicable speed limit Vapp will change.

In this example, the preliminary notification is performed by informing the driver by the notification device 20 that a new speed limit V_new will be applied to the host vehicle 100. More specifically, the preliminary notification is performed by displaying the road sign image IMG1 by the displaying device 21. The road sign image IMG1 is modeled after a road sign indicating the new applicable speed limit Vapp_new. Additionally or alternatively, the preliminary notification may be performed by outputting audio indicating the new applicable speed limit Vapp_new via the audio device 22.

As described above, when the vehicle driving assistance apparatus 10 recognizes that the applicable speed limit Vapp will change, and the driving situation of the host vehicle 100 satisfies the first situation condition C1, the vehicle driving assistance apparatus 10 is configured to perform the advance notification to inform the driver that the applicable speed limit Vapp will change before the applicable speed limit Vapp changes.

Further, the timing of the preliminary notification is earlier when the current vehicle speed V is greater than the applicable speed limit Vapp to be informed to the driver by the preliminary notification, compared to when the current vehicle speed V is lower than the applicable speed limit Vapp to be informed to the driver by the preliminary notification.

On the other hand, when the vehicle driving assistance apparatus 10 determines “No” in the step S235, the vehicle driving assistance apparatus 10 proceeds with the process directly to the step S295 to terminate the process of this routine once.

When the vehicle driving assistance apparatus 10 determines “No” in the step S210, the vehicle driving assistance apparatus 10 proceeds with the process to a step S245 to determine whether a normal notification condition C4 is satisfied.

The normal notification condition C4 is satisfied when the host vehicle 100 reaches a location where the new speed limit V_new begins to be applied to the host vehicle 100. It is determined whether the host vehicle 100 reaches the location where the new speed limit V_new begins to be applied to the host vehicle 100, based on the current position of the host vehicle 100 and the map information IM.

When the vehicle driving assistance apparatus 10 determines “Yes” in the step S245, the vehicle driving assistance apparatus 10 proceeds with the process to a step S250 to perform the normal notification. Then, the vehicle driving assistance apparatus 10 proceeds with the process to the step S295 to terminate the process of this routine once.

The normal notification is a notification to inform the driver that the new speed limit V_new is applied to the host vehicle 100. In other words, the normal notification is a notification to inform the driver that the applicable speed limit Vapp changes.

In this example, the normal notification is performed by informing the driver by the notification device 20 that the new speed limit V_new is applied to the host vehicle 100. More specifically, the normal notification is performed by displaying the road sign image IMG1 by the displaying device 21. The road sign image IMG1 is modeled after a road sign indicating the new applicable speed limit Vapp_new. Additionally or alternatively, the normal notification may be performed by outputting audio representing the new applicable speed limit Vapp_new from the audio device 22.

As described above, when the applicable speed limit Vapp changes, the vehicle driving assistance apparatus 10 is configured to perform the normal notification to inform the driver of the changed applicable speed limit Vapp.

On the other hand, when the vehicle driving assistance apparatus 10 determines “No” in the step S245, the vehicle driving assistance apparatus 10 proceeds directly to the step S295 to terminate the process of this routine once.

The above describes the operation of the vehicle driving assistance apparatus 10.

In a situation where the first situation condition C1 is satisfied, or in a situation where the first situation condition C1 and the second situation condition C2 are satisfied, if the driver is informed of the change in the applicable speed limit Vapp after the applicable speed limit Vapp changes, the driver's attention may be distracted. In other words, in a situation where the first situation condition C1 is satisfied, or in a situation where the first situation condition C1 and the second situation condition C2 are satisfied, if information regarding the speed limit Vlim such as information indicating that the applicable speed limit Vapp changes, is provided to the driver after the applicable speed limit Vapp changes, there is a possibility that the driver's attention will be distracted.

According to the vehicle driving assistance apparatus 10, when the first situation condition C1 is satisfied, or when the first situation condition C1 and the second situation condition C2 are satisfied, the driver is informed that the applicable speed limit Vapp will change before the applicable speed limit changes. Therefore, distraction of the driver's attention can be suppressed.

It should be noted that the present invention is not limited to the aforementioned embodiments, and various modifications can be employed within the scope of the invention.

For example, the vehicle driving assistance apparatus 10 may be configured not only to inform the driver of the applicable speed limit Vapp, but also to provide notifications regarding locations where a stop is required or where road construction is being carried out. In this case, the locations where a stop is required or where road construction is being carried out, are acquired from the image information IC.

What is claimed is:

1. A vehicle driving assistance apparatus comprising an electronic control unit configured to perform a normal notification when an applicable speed limit to be applied to a host vehicle changes, the normal notification being a notification that informs an operator of the host vehicle of the changed applicable speed limit,
wherein the electronic control unit is configured to perform an advance notification when the electronic control unit recognizes that the applicable speed limit will change and a predetermined situation condition related to a driving situation of the host vehicle is satisfied before the applicable speed limit changes, the advance notification being a notification that informs the operator that the applicable speed limit will change.

2. The vehicle driving assistance apparatus according to claim 1, wherein the electronic control unit is configured to perform the advance notification in a different manner from the normal notification, even when the electronic control unit informs the operator of the same applicable speed limit.

3. The vehicle driving assistance apparatus according to claim 1, wherein the electronic control unit is configured to perform the advance notification at an earlier timing when a traveling speed of the host vehicle is greater than the applicable speed limit informed by the advance notification, compared to when the traveling speed is lower than the applicable speed limit.

4. The vehicle driving assistance apparatus according to claim 1, wherein the predetermined situation condition is a condition that the weather in the vicinity of the host vehicle is inclement.
